(19) United States
(12) Patent Application Publication
(10) Pub. No.: US 2015/0065604 A1
(43) Pub. Date: Mar. 5, 2015

(54) Microcapsules For Paints And Lacquers

(71) Applicant: Cognis IP Management GmbH, Dusseldorf (DE)

(72) Inventors: Joaquin Bigorra Llosas, Sabadell (ES); Elisabet Graupera, Sabadell (ES); Bernd Fabry, Korschenbroich (DE); Raymond Mathis, Dusseldorf (DE); Paul Birnbrich, Solingen (DE)

(21) Appl. No.: 14/535,722

(22) Filed: Nov. 7, 2014

Related U.S. Application Data
(63) Continuation of application No. 11/739,129, filed on Apr. 24, 2007, now abandoned.

(30) Foreign Application Priority Data
May 9, 2006 (EP) 06009484.4

(51) Int. Cl. C09D 5/14; C08K 5/134; C09D 137/00

(52) U.S. Cl. CPC C09D 5/14; C09D 137/00; C08K 5/134
USPC 523/122

(57) ABSTRACT

A paint or lacquer composition including microcapsules, which microcapsules are prepared according to the process including: (a) providing a mixture of an active and a polyvinylether; (b) polymerizing the mixture with maleic anhydride to form a copolymer matrix; and (c) cross-linking the copolymer matrix with a melamine-formalin resin to encapsulate the active in microcapsules with an average diameter of about 0.1 to about 25 μm for incorporating into a paint or a lacquer composition is provided.

### CROSS-REFERENCE TO RELATED APPLICATIONS

This application is a continuation of U.S. application Ser. No. 11/739,129, filed on Apr. 24, 2007, which claims priority under 35 U.S.C. §119 to European Patent Application No. 06009484.4, filed May 9, 2006, granted as European Patent 1 854 850, on Aug. 12, 2009, the contents of each of which are hereby incorporated by reference in their entireties.

### TECHNICAL FIELD

The present invention relates to paints and lacquers, and more particularly, relates to defined types of encapsulated actives for paints and lacquers, and paints and lacquers comprising said encapsulated actives.

### BACKGROUND

Paint and lacquer compositions typically include colorant particles dispersed in a resinous binder. In addition, those products may comprise further auxiliaries, more particularly, active ingredients providing, for example, a fresh smell, or protecting the objects which have been treated with the paints or lacquers against insects, corrosion and the like. Unfortunately, very often those actives do not show a sufficient stability in the final composition, since they either interfere with other ingredients or they are simply disintegrated by light or water. A simple solution to this problem could be to encapsulate such actives in order to achieve both the protection of the compounds and their controlled release over a longer period of time. Nevertheless, what one can observe is that well-known microcapsules, for example, based on gelatine as a matrix, show a strong tendency to increase the viscosity of the paints and lacquers, especially when storage takes place at elevated temperatures, which is definitely unwanted by the customer. Another serious disadvantage is that paints comprising common microcapsules when applied onto a surface provide films of poor quality, since they show a lot of visual defects, for example, spots and craters, because the size distribution is not narrow enough and comprises too many individuals with high diameters.

### SUMMARY

Briefly described, a paint or lacquer composition includes microcapsules, which microcapsules are prepared according to the process including (a) providing a mixture of an active and a polyvinylether; (b) polymerizing the mixture with maleic anhydride to form a copolymer matrix; and (c) cross-linking the copolymer matrix with a melamine-formalin resin to encapsulate the active in microcapsules with an average diameter of about 0. 1 to about 25 μm for incorporating into a paint or a lacquer composition.

### DETAILED DESCRIPTION

An aspect of the present invention has therefore been to provide a solution to said complex problem and to develop paints and lacquers comprising encapsulated actives which show an improved storage stability and exhibit a superior film quality.

The present invention claims the use of microcapsules having an average diameter of 0.1 to 25 μm, obtainable in that a mixture of actives and polyvinylethers (PVE) is polymerized with maleic anhydride (MA), followed by a cross-linking reaction with melamineformalin resins, for making paints and lacquers.

Surprisingly, it has been found that the cited microcapsules obtained from the polymerization of polyvinylethers in general and particularly polyvinylmethyl ether (PVME), and MA solve the complex problem, since they do not raise the viscosity when introduced into the final formulation, even when stored at elevated temperatures over a period of two months. Moreover, the paint films do not exhibit visual defects, spots or craters due to the fact that the specific microcapsules show a regular form with a soft, flexible shell and exhibit a small and narrow size distribution.

Therefore, microcapsules which were found particular useful for the claimed application, show a size distribution where at least 50% b.w. of said capsules have a diameter between 0.5 and 5 μm and more particularly between 1 and 4 μm.

Actives

Although the nature of the active is not critical for the present invention, preferred examples are perfumes, fragrances, aromas, insecticides and biocides.

Perfumes, Fragrances, and Aromas

Suitable perfume oils are mixtures of natural and synthetic perfumes. Natural perfumes include the extracts of blossoms (lily, lavender, rose, jasmine, neroli, ylang-ylang), stems and leaves (geranium, patchouli, petitgrain), fruits (anise, coriander, caraway, juniper), fruit peel (bergamot, lemon, orange), roots (nutmeg, angelica, celery, cardamom, costus, iris, calmus), woods (pinewood, sandalwood, guaiac wood, cedarwood, rosewood), herbs and grasses (tarragon, lemon grass, sage, thyme), needles and branches (spruce, fir, pine, dwarf pine), resins and balsams (galbanum, elemi, benzoin, myrrh, olibanum, opoponax). Animal raw materials, for example civet and beaver, may also be used. Typical synthetic perfume compounds are products of the ester, ether, aldehyde, ketone, alcohol and hydrocarbon type. Examples of perfume compounds of the ester type are benzyl acetate, phenoxyethyl isobutyrate, p-tert.butyl cyclohexylacetate, linalyl acetate, dimethyl benzyl carbinyl acetate, phenyl ethyl acetate, linalyl benzoate, benzyl formate, ethylmethyl phenyl glycinate, allyl cyclohexyl propionate, styrallyl propionate and benzyl salicylate. Ethers include, for example, benzyl ethyl ether while aldehydes include, for example, the linear alkanals containing 8 to 18 carbon atoms, citral, citronellal, citronellyloxyacetaldehyde, cyclamen aldehyde, hydroxycitronellal, lilial and bourgeonal. Examples of suitable ketones are the ionones, isomethylionone and methyl cedryl ketone. Suitable alcohols are anethol, citronellol, eugenol, isoeugenol, geraniol, linalool, phenylethyl alcohol and terpineol. The hydrocarbons mainly include the terpenes and balsams. However, it is preferred to use mixtures of different perfume compounds which, together, produce an agreeable perfume. Other suitable perfume oils are essential oils of relatively low volatility which are mostly used as aroma components. Examples are sage oil, camomile oil, clove oil, melissa oil, mint oil, cinnamon leaf oil, lime-blossom oil, juniper berry oil, vetiver oil, olibanum oil, galbanum oil, ladanum oil and lavendin oil. The following are preferably used either individually or in the form of mixtures: bergamot oil, dihydromyrcenol, lilial, lyral, citronellol, phenylethyl alcohol, hexylcinnamaldehyde, geraniol, benzyl acetone, cyclamen aldehyde, linalool, Boisambrene Forte, Ambroxan, indole, hedione, sandelice, citrus oil, mandarin oil, orange oil, allylamyl glycolate, cyclovertal, lavendin oil, clary oil, damascone, geranium oil bourbon, cyclohexyl salicylate, Vertofix Coeur, Iso-E-Super, Fixolide NP, evernyl, iraldein gamma, phenylacetic acid, geranyl acetate, benzyl acetate, rose oxide, romillat, irotyl and floramat.

Insecticides and Biocides

Examples for suitable insecticides and biocides are sesquiterpenes, Diethyltoluamid (DEET), Ethyl Butylacetylaminopropionat (IR3535), Hydroxyethyl Isobutyl Piperidine Carboxylate and preferably pyrethroides and their mixtures. Typical representatives for pyrethroides are 5-Benzyl-3-furylmethyl (+)-cis-(1R,3S,E) 2,2-dimethyl-3-(2-oxo-2,3,4,5-tetrahyfrothiophenyliden methyl)cyclopropancarboxylate, 6-Chloropiperonyl 2,2-dimethyl-3-(2-methylpropenyl)cyclo propancarboxylate, Acrinathrin, Allethrin, Bifentrin, Bioresmethrin, Cismethrin, Cyclethrin, Cycloprothrin, Cyfluthrin, Cyhalothrin, Cypermethrin, Cyphenotrin, Deltamethrin, Dimethrin, Empenthrin, Esfenvalerat, Fenfluthrin, Fenpropathrin, Fenvalerat, Flucythrinat, Flumethrin, Fluvalinat, Furethrin, Halfenprox, hniprothrin. Methyl cis/trans-3-(2,2-dichlorovinyl)-2,2-dimethylcyclopropan-1-carboxylat, and particularly Permethrin and their mixtures. Also useful as biocides are certain pigments like the oxides of copper.

Preparation of the Micro-Capsules

Capsules obtainable by polymerization of vinyl ethers and maleic anhydride followed by cross-linking with a melamine-formalin resin are known from the prior art. For example, German patent application DE 3512565 A1 (BASF) discloses such capsules comprising paraffins as actives for the surface treatment of copy papers. Another process is disclosed in U.S. Pat. No. 4,089,802 (NRC Corp.). The teaching of these documents as far as the preparation of the capsules to be used according to the present invention is therefore fully incorporated herein by reference.

Industrial Application

As outlined above, the microcapsules used according to the present invention exhibit superior properties to paints and lacquers than other capsules found in the market. Therefore, another object of the present invention is directed to paints and lacquers comprising microcapsules having an average diameter of 0. 1 to 25 μm, and obtainable in that a mixture of actives and polyvinylethers, more particularly polyvinylmethylether is polymerized with maleic anhydride (MA) and subsequently cross-linked with a melamineformalin resin.

In particular, those paints and lacquers comprising microcapsules are preferred where at st 50% b.w. of said capsules show a diameter of 0.1 to 5 μm. Typically, the content of said microcapsules in said paints and lacquers lies between 0.01 and 15, preferably 0.1 to 10 and more preferably 1 to 5% b.w.

### EXAMPLES

All applications tests were performed by adding 0.5% b.w. of an encapsulated active (permethrin, 0.5% b.w.) in a polyvinylmethylether/maleic anhydride copolymer matrix, cross-linked with a melamine-formalin resin according to DE 3512565 A1—calculated as active matter—either to a semi-gloss paint (Pintura Satinada Ciclón, Bruguer) or a flat paint (Pintura Mate Ciclón, Bruguer) under vigorous stifling (2,000 rpm, 10 min). Once the products were homogenised the following parameters were determined:
Paint viscosity (according to Brookfield) after the addition of the capsules and paint stability after storage at 45° C.;
Preparation of films (20 g of paint) by means of a brush (visual defects);
Paint draw down at 100 μm(visual defects).

The tests according to the present invention were conducted with microcapsules obtained according to working example 1. The results are shown in Table 1.

TABLE 1
Application Tests

| Examples | C1 | 1 | 2 | 3 |
|---|---|---|---|---|
| Degree of Encapsulation | 0 | 15 | 27 | 27 |
| [%] | | | | |
| Quantity Added (=0.5% | — | 3.33 | 1.85 | 1.85 |
| b.w. active) | | | | |

Flat Paint

| | | | | |
|---|---|---|---|---|
| Viscosity, 25° C. [mPas] | 7,800 | 8,100 | 9,600 | 10,700 |
| Viscosity, 6 d, 45° C. | 10,650 | 11,100 | 14,300 | 13,000 |
| [mPas] | | | | |
| Brush Test | Ok | Ok | Ok | Ok |
| Dray down test | no defects | no defects | no defects | no defects |

Satin Paint

| | | | | |
|---|---|---|---|---|
| Viscosity, 25° C. [mPas] | 7,000 | 6,300 | 7,000 | 7,100 |
| Viscosity, 6 d, 45° C. | 7,100 | 6,300 | 7,600 | 7,500 |
| [mPas] | | | | |
| Brush test | Ok | Ok | Ok | Ok |
| Dray down test | no defects | no defects | no defects | no defects |

As one can see, the microcapsules according to the present invention allow the manufacture of flat and semi-gloss paints with stable viscosity. In the application, said paints exhibit an excellent performance, and the obtained films do not show any defects or spots or craters.

What is claimed is:

1. A paint or lacquer composition comprising microcapsules that comprise an active that is encapsulated by walls comprising a polyvinylether-maleic anhydride copolymer matrix having cross-links consisting of repeating units derived from melamine and formalin, which microcapsules are prepared according to a process consisting of the steps of:
(a) firstly providing a mixture of an active, selected from the group consisting of perfumes, fragrances, aromas, insecticides, biocides, and mixtures thereof, and a polyvinylether;
(b) secondly polymerizing the mixture with maleic anhydride to form a copolymer matrix; and
(c) thirdly cross-linking the copolymer matrix with a resin consisting of repeating units derived from melamine and formalin, to encapsulate the active in microcapsules with an average diameter of about 0.1 to about 25 μm,
wherein said microcapsules are incorporated into a latex paint composition or lacquer composition, and
wherein at least 50% by weight of said microcapsules have a diameter of about 0.5 to about 5 μm.

2. The paint or lacquer composition according to claim 1, wherein the polyvinylether is polyvinylmethylether.

3. The paint or lacquer composition according to claim 1, wherein said microcapsules have a diameter of about 1 to about 4 μm.

4. The paint or lacquer composition according to claim 1, wherein said microcapsules are added to a latex paint or a lacquer in an amount of from about 0.001 to about 25% by weight.

5. The paint or lacquer composition according to claim 2, wherein said microcapsules are added to a latex paint or a lacquer in an amount of from about 0.001 to about 25% by weight.

6. The paint or lacquer composition according to claim 3, wherein said microcapsules are added to a latex paint or a lacquer in an amount of from about 0.001 to about 25% by weight.

7. A method of preparing a paint or lacquer composition comprising microcapsules that comprise an active that is encapsulated by walls comprising a polyvinylether-maleic anhydride copolymer matrix having cross-links consisting of repeating units derived from melamine and formalin, which method comprises the steps of:
(1) preparing microcapsules according to a process consisting of the steps of:
(a) providing a mixture of an active, selected from the group consisting of perfumes, fragrances, aromas, insecticides, biocides and mixtures thereof, and a polyvinylether;
(b) polymerizing said mixture with maleic anhydride to form a copolymer matrix; and
(c) cross-linking said copolymer matrix with a resin consisting of repeating units derived from melamine and formalin, to encapsulate the active in microcapsules,
wherein at least 50% by weight of said microcapsules have a diameter of about 0.5 to about 5 μm; and
(2) adding said microcapsules to a latex paint or lacquer base.

8. The method of claim 7, wherein said polyvinylether is polyvinylmethylether.

9. The method of claim 7, wherein said microcapsules have a diameter of about 1 to about 4 μm.

10. The method of claim 7, wherein said microcapsules are added to a latex paint or a lacquer base in an amount of from about 0.001 to about 25% by weight.
